(19) United States
(12) Patent Application Publication
(10) Pub. No.: US 2014/0211765 A1
(43) Pub. Date: Jul. 31, 2014

(54) WIRELESS COMMUNICATION DEVICE, CONTROL PROGRAM AND CONTROL METHOD

(71) Applicant: FUJITSU LIMITED, Kawasaki-shi (JP)

(72) Inventor: Naritoshi SAITO, Hino (JP)

(73) Assignee: FUJITSU LIMITED, Kawasaki-shi (JP)

(21) Appl. No.: 14/098,993

(22) Filed: Dec. 6, 2013

(30) Foreign Application Priority Data
Jan. 25, 2013 (JP) 2013-012538

(51) Int. Cl. H04L 5/00

(52) U.S. Cl. CPC H04L 5/0092
USPC 370/336

(57) ABSTRACT

A wireless communication device includes a memory, and a processor coupled to the memory and configured to specify a timing for transmitting a signal for requesting information about a second base station that is used for voice data communication when conducting outgoing or incoming voice communication while conducting communication through a first base station that is used for data communication other than voice communication, transmit, in accordance with the specified timing, the signal for requesting the information about the second base station, and adjust by advancing the specified timing when a request for conducting incoming or outgoing voice communication is received.

### CROSS-REFERENCE TO RELATED APPLICATION

This application is based upon and claims the benefit of priority from the prior Japanese Patent Application No. 2013-012538 filed on Jan. 25, 2013, the entire contents of which are incorporated herein by reference.

### FIELD

The embodiments discussed herein relate to a wireless communication device.

### BACKGROUND

Recently, multi-wireless terminals exist that are able to connect to a network using a plurality of communication protocols such as the 1× protocol, the evolution-data only (EVDO) protocol, and the long-term evolution (LTE) protocol. The 1× protocol is one of the technical specifications that are included in the code division multiple access (CDMA) 2000 standard. The EVDO protocol is a standard that improves upon the 1× protocol with specialized packet communication and improved communication speeds. The LTE protocol is a standard for using communication by the orthogonal frequency division multiplexing access (OFDMA) protocol.

Japanese Laid-open Patent Publication No. 2010-147576 and Japanese Laid-open Patent Publication No. 2010-063014 are examples of related art.

### SUMMARY

According to an aspect of the invention, a wireless communication device includes a memory, and a processor coupled to the memory and configured to specify a timing for transmitting a signal for requesting information about a second base station that is used for voice data communication when conducting outgoing or incoming voice communication while conducting communication through a first base station that is used for data communication other than voice communication, transmit, in accordance with the specified timing, the signal for requesting the information about the second base station, and adjust by advancing the specified timing when a request for conducting incoming or outgoing voice communication is received.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example of a multi-wireless system of a present embodiment.

FIG. 2 illustrates a 1×/EVDO protocol communication area and LTE protocol communication areas.

FIG. 3 is a functional block diagram of a configuration of a multi-wireless terminal according to the first embodiment.

FIG. 4 is a functional block diagram of a configuration of a control unit.

FIG. 5 illustrates an example of a data structure of SIB information.

FIG. 6 is a flowchart of an example of operating procedures pertaining to a LTE RACH transmission by the multi-wireless terminal.

FIG. 7 is a first flowchart of operating procedures of a first LTE RACH transmission process.

FIG. 8 is a second flowchart of operating procedures of the first LTE RACH transmission process.

FIG. 9 describes a wireless terminal device for conducting a control program.

FIG. 10 illustrates an example of operating procedures for sending the LTE RACH.

### DESCRIPTION OF EMBODIMENT

An embodiment of a wireless communication device, a control program, and a control method described hereinafter will be explained with reference to the accompanying drawings. The present disclosure is not limited to the embodiment disclosed herein.

While inventing the present embodiments, observations were made regarding a related art. Such observations include the following, for example.

A multi-wireless terminal of the related art uses the 1× protocol for voice communication and uses the EVDO protocol or the LTE protocol for packet communication. The multi-wireless terminal often prioritizes the LTE protocol since the communication speed with the LTE protocol is higher than that of the EVDO protocol.

The multi-wireless terminal is expected to exhibit power saving while wirelessly connected with the LTE protocol and may disconnect not only wireless communication with the EVDO protocol, but also wireless communication with the 1× protocol. Voice communication is not performed while the 1× protocol wireless communication is disconnected. As a result, the multi-wireless terminal uses a function called a 1×CSFallback to detect an incoming voice communication and then switches to the 1× protocol. LTE paging is sent to the multi-wireless terminal with the 1×CSFallback when the incoming voice communication is received by the multi-wireless terminal.

The multi-wireless terminal that receives the LTE paging sends a LTE RACH to obtain information for conducting voice communication with the 1× protocol. For example, the information for conducting voice communication with the 1× protocol includes connection target base station information and security information.

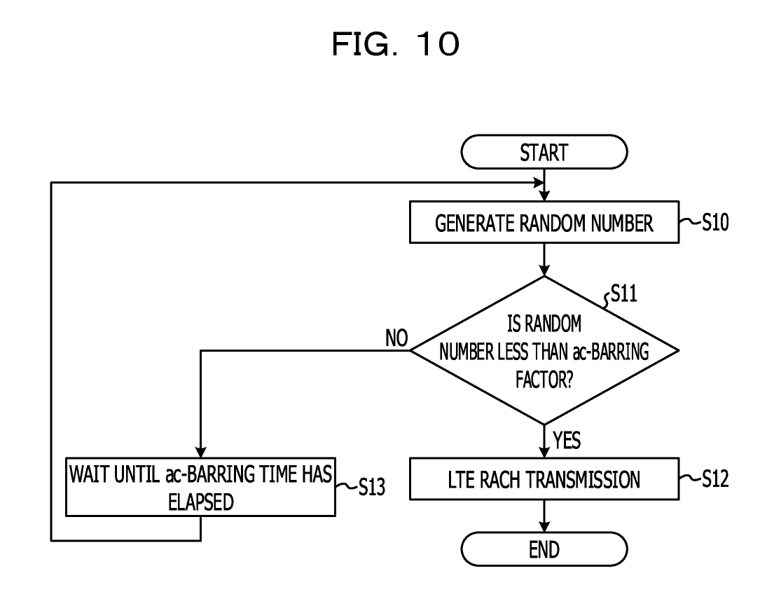

Predetermined operating procedures are followed when the multi-wireless terminal sends a LTE RACH. FIG. 10 illustrates an example of operating procedures for sending the LTE RACH. As illustrated in FIG. 10, the multi-wireless terminal is made to generate a random number (step S10) and then determines if the random number is less than an ac-Barring Factor (step S11). The ac-Barring Factor in step S11 is a numerical value notified by a host device.

If the random number is less than the ac-Barring Factor (step S11, Yes), the multi-wireless terminal sends the LTE RACH (step S12) and then ends the process. Conversely, if the ac-Barring Factor is not smaller than the random number (step S11, No), the multi-wireless terminal waits until the ac-Barring Time elapses (step S13) and then moves to step S10. The ac-Barring Time in step S13 is a time period notified by the host device.

Multi-wireless terminals of the related art execute the processing illustrated in FIG. 10 and, after sending the LTE RACH, obtain the information for conducting the voice communication with the 1× protocol and then conduct the voice communication using the 1× protocol. The multi-wireless terminals execute the processing illustrated in FIG. 10 in the same way when conducting an outgoing voice call and, after sending the LTE RACH, obtain the information for conducting the voice communication with the 1× protocol and then conduct voice communication using the 1× protocol.

However, there is a problem in that a certain amount of time is desired up to beginning voice communication with the abovementioned technique.

For example, the multi-wireless terminal executes the processing in FIG. 10 and sends the LTE RACH after receiving the LTE paging. A delay of four to eight seconds, for example, may occur until the LTE RACH is sent.

In consideration of the above, an object of one aspect is to provide a wireless communication device that allows the time period until voice communication is started to be reduced.

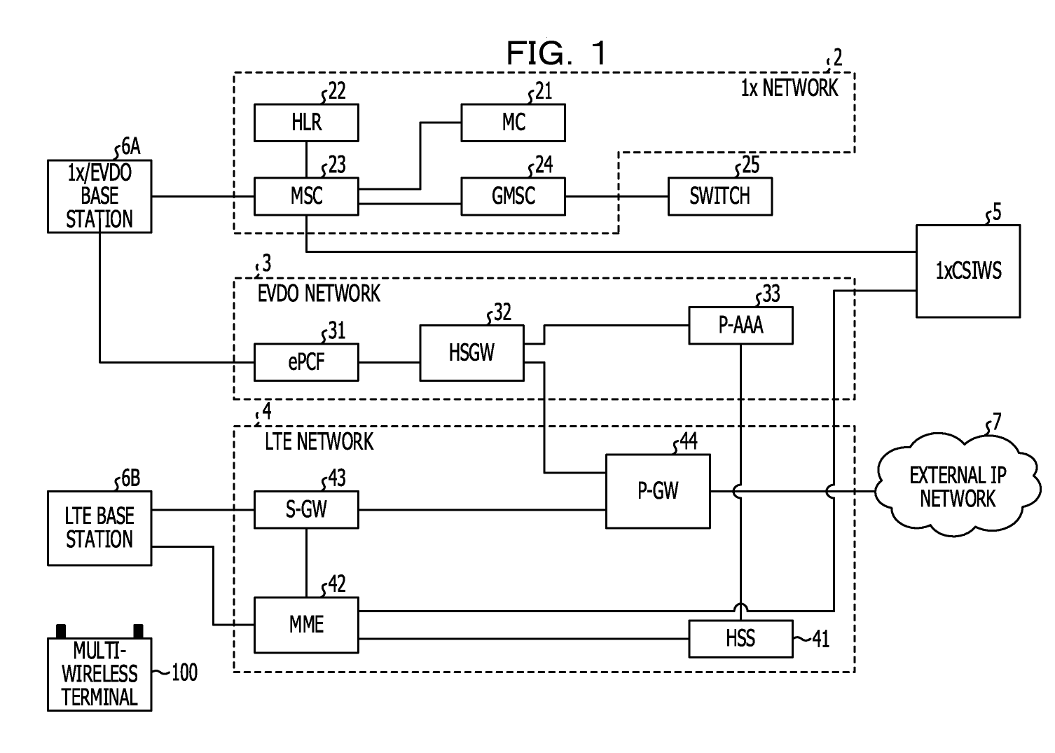

FIG. 1 is an example of a multi-wireless system of a present embodiment. As illustrated in FIG. 1, a multi-wireless system has a 1× network 2, an EVDO network 3, a LTE network 4, and a 1×CSIWS 5.

The 1× network 2 is connected to a 1×/EVDO base station 6A, the 1×CSIWS 5, and a switch 25. The EVDO network 3 is connected to the 1×/EVDO base station 6A. The LTE network 4 is connected to a LTE base station 6B, the 1×CSIWS 5, and an external internet protocol (IP) network 7. Although not represented in FIG. 1, a plurality of 1×/EVDO base stations and LTE base stations are assumed to be present in the system.

The 1× network 2 has a message center (MC) 21, a home location register (HLR) 22, a mobile switching center (MSC) 23, and a gateway mobile switching center (GMSC) 24. The MC 21 distributes messages for example. The HLR 22 registers and manages subscriber information, position information and confirmation information of service subscribers in the 1× network 2 in association with each other. The MSC 23 is switch connected with the 1×/EVDO base station 6A. The GMSC 24 connects the MSC 23 and the switch 25 that is connected with, for example, a public switched telephone network (PSTN)/integrated services digital network 1 (ISDN1).

The EVDO network 3 has an evolved packet control function (ePCF) 31, a high rate packet data serving gateway (HSGW) 32, and a proxy-authentication, authorization and accounting (P-AAA) 33. The ePCF 31 is connected to the 1×/EVDO base station 6A and is responsible for a packet routing function. The HSGW 32 conducts conversion to EVDO protocol high speed packet data. The P-AAA 33 manages the authentications, authorizations, and billing of subscribers in the EVDO network 3.

The LTE network 4 has a home subscriber server (HSS) 41, a mobility management entity (MME) 42, a serving gateway (S-GW) 43, and a packet data network gateway (P-GW) 44. The HSS 41 manages subscriber information and the like in the LTE network 4. The MME 42 connects the LTE base station 6B with the S-GW 43, and is responsible for network control such as sequencing control inside the LTE network 4, handover functions, position management of service subscribers, and paging functions when incoming calls are received for the LTE base station 6B. The S-GW 43 is connected to the LTE base station 6B and is responsible for a packet routing function. The P-GW 44 is a gateway for communicable connections between the HSGW 32 in the EVDO network 3, the external IP network 7, and the S-GW 43. The P-GW 44 conducts seamless packet communication between, for example, the EVDO network 3 and the LTE network 4. Moreover, the HSS 41 and the P-AAA 33 are used in conjunction by the EVDO network 3 and the LTE network 4.

The 1×CSIWS 5 connects the MSC 23 and the MME 42.

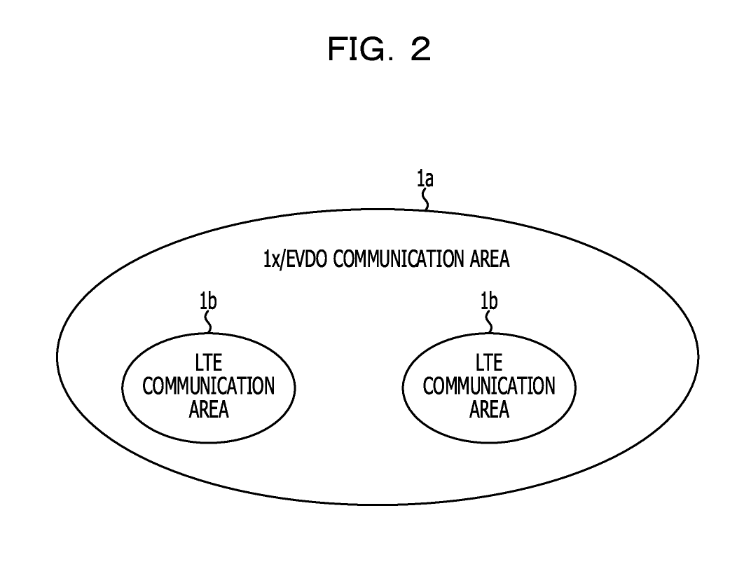

In Japan, existing cells of the 1× protocol and the EVDO protocol are present and carry out services with a 98% coverage ratio of the population of mobile telephones. However, the LTE protocol is a new standard and the multi-wireless terminal is not necessarily able to conduct packet communication using the LTE protocol since the coverage ratio of the population of mobile telephones is about 80%. FIG. 2 illustrates a 1×/EVDO protocol communication area and LTE protocol communication areas. As illustrated in FIG. 2, a communication area 1a for the 1×/EVDO protocol is able to cover a large area. In contrast, communication areas 1b for the LTE protocol are smaller than the communication area 1a.

A multi-wireless terminal 100 is a service subscriber terminal that is compatible with wireless communications in the multi-wireless system illustrated in FIG. 1. The multi-wireless terminal 100 is able to save power by disconnecting wireless communication with the EVDO protocol and also with the 1× protocol when wirelessly connected with the LTE base station 6B and the LTE network 4.

When an incoming voice call for the multi-wireless terminal 100 occurs while the multi-wireless terminal 100 is wirelessly connected using only the LTE protocol, the system illustrated in FIG. 1 notifies the multi-wireless terminal 100 about the incoming voice call using LTE paging. The multi-wireless terminal 100 then carries out the 1× protocol wireless communication and the user is able to conduct voice communication through a wirelessly connection with the 1×/EVDO base station 6A. In this way, the function for notifying the multi-wireless terminal 100 that an incoming voice call for the multi-wireless terminal 100 conducting wireless communication with the LTE protocol has occurred and for connecting the multi-wireless terminal 100 to the 1×/EVDO base station 6A is called LTE 1×CSFallback.

The following is an explanation of the LTE 1×CSFallback. The multi-wireless terminal 100 is not wirelessly connected with the 1×/EVDO base station 6A while the multi-wireless terminal 100 is wirelessly connected with the LTE base station 6B. As a result, the MSC 23 notifies the MME 42 through the 1×CSIWS 5 the fact that an incoming voice call has occurred when the MSC 23 detects the incoming voice call for the multi-wireless terminal 100. The MME 42 that receives the notification transmits Paging to the multi-wireless terminal 100 from the LTE base station 6B.

The multi-wireless terminal 100 that receives the paging transmits the LTE RACH to obtain the 1×/EVDO base station information and the security information for allowing the wireless connection with the 1×/EVDO base station 6A. The 1×/EVDO base station information includes cell IDs and information for identifying the 1×/EVDO base station 6A to become the connection target of the multi-wireless terminal 100 from among a plurality of 1×/EVDO base stations. The security information includes authentication information for the multi-wireless terminal 100. A more detailed explanation of the LTE 1×CSFallback will be omitted here since the information is described in the 3rd Generation Partnership Project (3GPP) standard TS23.272.

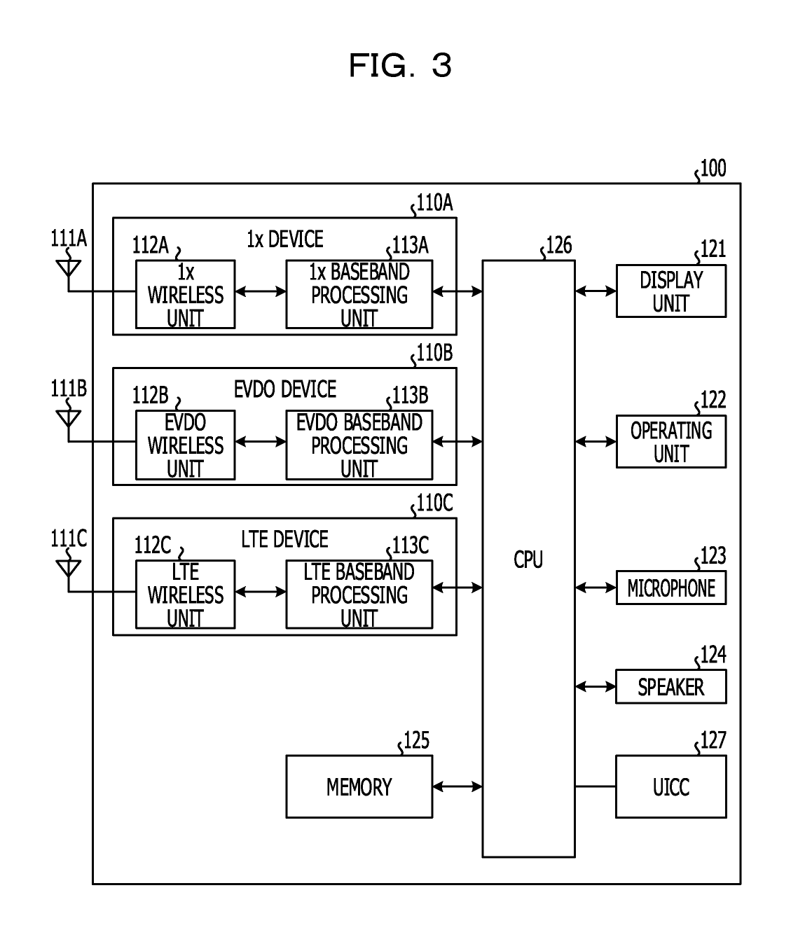

The following is an explanation of the configuration of the multi-wireless terminal 100 according to the present embodiment illustrated in FIG. 1. FIG. 3 is a functional block diagram of a configuration of a multi-wireless terminal according to the present embodiment. As illustrated in FIG. 3, the multi-wireless terminal 100 has a 1× device 110A, an EVDO device 110B, and a LTE device 110C. The multi-wireless terminal 100 has a display unit 121, an operating unit 122, a microphone 123, a speaker 124, a memory 125, and a central processing unit (CPU) 126. Furthermore, the multi-wireless terminal 100 includes a UICC 127 that is removable and attachable. The UICC 127 stores, for example, SIB information and the like.

The 1× device 110A is an interface responsible for wireless communication with the 1× network 2. The 1× device 110A has an antenna 111A, a 1× wireless unit 112A, and a 1× baseband processing unit 113A. The 1× wireless unit 112A receives wireless signals of various types of data such as voice and text conforming to the 1× protocol via the antenna 111A, and converts the frequency of the received wireless signals. The 1× baseband processing unit 113A converts the wireless signals frequency-converted by the 1× wireless unit 112A into baseband signals and demodulates the converted baseband signals. The 1× baseband processing unit 113A also modulates transmission data into baseband signals. The 1× wireless unit 112A converts the frequency of the baseband signals modulated by the 1× baseband processing unit 113A and outputs and transmits the frequency-converted transmission signals via the antenna 111A.

The EVDO device 110B is an interface responsible for wireless communication with the EVDO network 3. The EVDO device 110B has an antenna 111B, an EVDO wireless unit 112B, and an EVDO baseband processing unit 113B. The EVDO wireless unit 112B receives wireless signals of various types of data such as voice and text conforming to the EVDO protocol via the antenna 111B, and converts the frequency of the received wireless signals. The EVDO baseband processing unit 113B converts the wireless signals frequency-converted by the 1× wireless unit 112A into baseband signals and demodulates the converted baseband signals. The EVDO baseband processing unit 113B also modulates transmission data into baseband signals. The EVDO wireless unit 112B converts the frequency of the baseband signals modulated by the EVDO baseband processing unit 113B and outputs and transmits the frequency-converted transmission signals via the antenna 111B.

The LTE device 110C is an interface responsible for wireless communication with the LTE network 4. The LTE device 110C has an antenna 111C, a LTE wireless unit 112C, and a LTE baseband processing unit 113C. The LTE wireless unit 112C receives wireless signals of various types of data such as voice and text conforming to the LTE protocol via the antenna 111C, and converts the frequency of the received wireless signals. The LTE baseband processing unit 113C converts the wireless signals frequency-converted by the LTE wireless unit 112C into baseband signals and demodulates the converted baseband signals. The LTE baseband processing unit 113C also modulates transmission data into baseband signals. The LTE wireless unit 112C converts the frequency of the baseband signals modulated by the LTE baseband processing unit 113C and outputs and transmits the frequency-converted transmission signals via the antenna 111C.

The display unit 121 is an output interface for displaying various types of information on a screen. The operating unit 122 is an input interface for inputting various types of information. The microphone 123 is an input interface for picking up various types of sounds. The speaker 124 is an output interface for outputting various types of sounds. The memory 125 is a region for storing various types of information. The CPU 126 is a device for controlling the entire multi-wireless terminal 100.

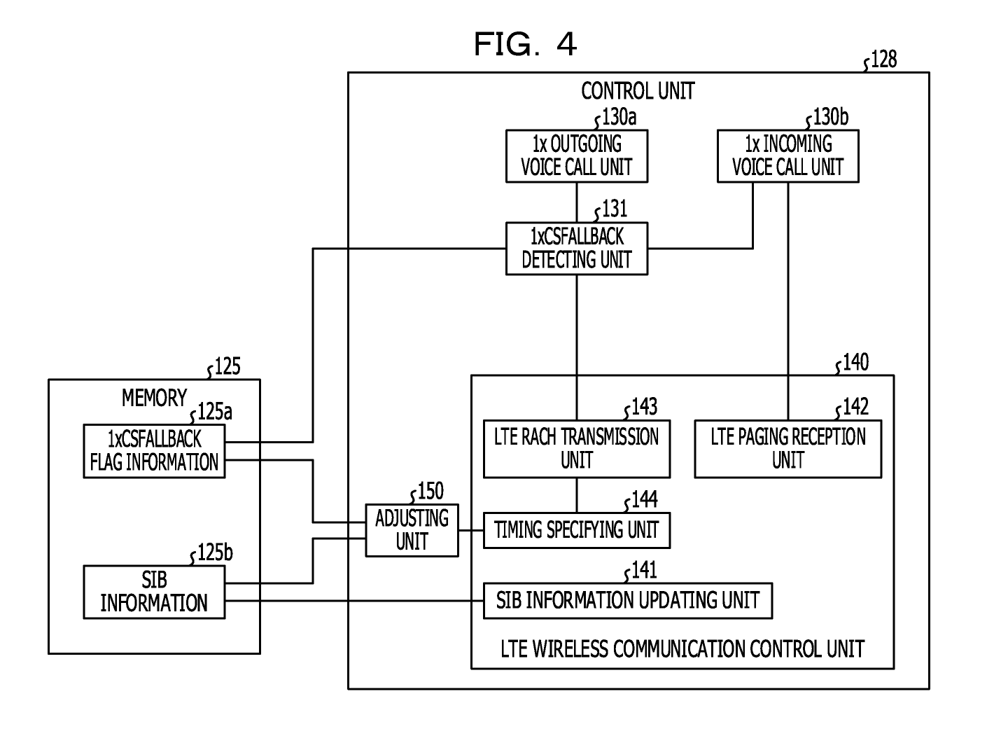

The following is an explanation of an exemplary configuration of a control unit included in the CPU 126 illustrated in FIG. 3. FIG. 4 is a functional block diagram of a configuration of a control unit. As illustrated in FIG. 4, a control unit 128 has a 1× outgoing voice call unit 130a, a 1× incoming voice call unit 130b, a 1×CSFallback detecting unit 131, a LTE wireless communication control unit 140, and an adjusting unit 150. The LTE wireless communication control unit 140 has a SIB information updating unit 141, a LTE paging reception unit 142, a LTE RACH transmission unit 143, and a timing specifying unit 144.

1×CSFallback flag information 125a and SIB information 125b, for example, are stored in the memory 125 connected to the CPU 126. The 1×CSFallback flag information 125a is information for indicating whether the multi-wireless terminal 100 is handling a 1×CSFallback voice outgoing/incoming call. For example, if the 1×CSFallback flag information 125a is “1”, the multi-wireless terminal 100 is handling a 1×CSFallback voice outgoing/incoming call. Conversely, if the 1×CSFallback flag information 125a is “0”, the multi-wireless terminal 100 is not handling a 1×CSFallback voice outgoing/incoming call.

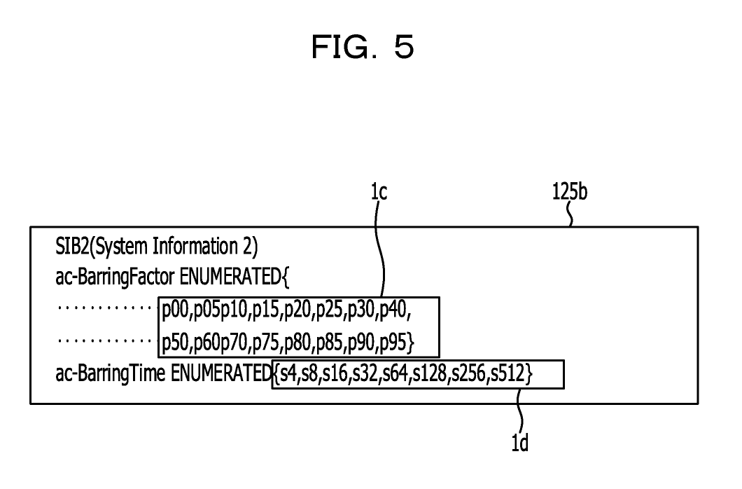

The SIB information 125b is information that includes an ac-Barring Factor value and an ac-Barring Time value when conducting a LTE RACH transmission. The ac-Barring Factor is a value for the belowmentioned timing specifying unit 144 to compare with a random number. The ac-Barring Time is a waiting time for the timing specifying unit 144 to perform a retry. FIG. 5 illustrates an example of a data structure of SIB information. The numerical values indicated as 1c represent the ac-Barring Factor in the example illustrated in FIG. 5. For example, p00, p05, p90 respectively represent 0.0, 0.5, and 0.9. The timing specifying unit 144 uses any of the numerical values among the numerical values indicated by 1c for comparison with a random number. The numerical values indicated as 1d represent the ac-Barring Time. For example, s4, s8, and s16 respectively represent 4 seconds, 8 seconds, and 16 seconds. The timing specifying unit 144 uses any of the numerical values among the numerical values indicated by 1d for conducting a retry.

The 1× outgoing voice call unit 130a is a processing unit for detecting an outgoing voice transmission operation by a user of the multi-wireless terminal 100. For example, the user operates the operating unit 122 illustrated in FIG. 3 to conduct an outgoing call operation. The 1× outgoing voice call unit 130a outputs the information indicating that a 1× outgoing voice transmission has been detected to the 1×CSFallback detecting unit 131 when an outgoing voice transmission operation by the user has been detected.

The 1× incoming voice call unit 130b is a processing unit for detecting an incoming voice transmission to the multi-wireless terminal 100. The 1× incoming voice call unit 130b outputs information indicating that a 1× incoming voice call has been detected to the 1×CSFallback detecting unit 131 when information indicating that paging has been received is received from the LTE wireless communication control unit 140.

The 1×CSFallback detecting unit 131 is a processing unit for setting the 1×CSFallback flag information 125a to “1” or “0” on the basis of information obtained from the 1× outgoing voice call unit 130a, the 1× incoming voice call unit 130b, and the LTE RACH transmission unit 143. The 1×CSFallback detecting unit 131 also outputs a LTE RACH transmission request to the LTE RACH transmission unit 143 when information indicating that a 1× outgoing voice call has been detected is obtained from the 1× outgoing voice call unit 130a, and when information indicating that a 1× incoming voice call has been detected is obtained from the 1× incoming voice call unit 130b.

The 1×CSFallback detecting unit 131 sets the 1×CSFallback flag information 125a to “1” when information indicating that a 1× outgoing voice call has been detected is obtained from the 1× outgoing voice call unit 130a. The 1×CSFallback detecting unit 131 sets the 1×CSFallback flag information 125a to “1” when information indicating that a 1× incoming voice call has been detected is obtained from the 1× incoming voice call unit 130b. The 1×CSFallback detecting unit 131 sets the 1×CSFallback flag information 125a to “0” when information indicating that a LTE RACH transmission has been conducted is obtained from the LTE RACH transmission unit 143.

The SIB information updating unit 141 is a processing unit for updating the SIB information 125b stored in the memory 125 according to received SIB information when the SIB information is received from the LTE base station 6B.

The LTE paging reception unit 142 is a processing unit for receiving paging from the LTE base station 6B. The LTE paging reception unit 142 outputs information indicating that paging has been received to the 1× incoming voice call unit 130b when the paging is received. The MSC 23 transmits the paging to the multi-wireless terminal 100 when an incoming voice call for the multi-wireless terminal 100 occurs in a state in which the multi-wireless terminal 100 is wirelessly connected to the LTE base station 6B and disconnected from the 1×/EVDO base station 6A. As explained in FIG. 1, the MSC 23 transmits the paging to the multi-wireless terminal 100 through the 1×CSIWS 5, the MME 42, and the LTE base station 6B.

The LTE RACH transmission unit 143 is a processing unit for transmitting the LTE RACH to the LTE base station 6B after the LTE RACH transmission request has been received from the 1×CSFallback detecting unit 131. The LTE RACH transmission unit 143 uses the timing specifying unit 144 to specify the timing for transmitting the LTE RACH when the LTE RACH transmission request is received.

The multi-wireless terminal 100 obtains the information of the 1×/EVDO base station and the security information due to the LTE RACH transmission unit 143 transmitting the LTE RACH. The multi-wireless terminal 100 wirelessly connects with the 1×/EVDO base station 6A and begins the voice communication based on the 1×/EVDO base station information and the security information.

The timing specifying unit 144 is a processing unit for specifying the timing at which the LTE RACH transmission unit 143 transmits the LTE RACH. The timing specifying unit 144 generates a random number and then notifies the LTE RACH transmission unit 143 about a timing in which the value of the generated random number is smaller than the ac-Barring Factor as the timing for transmitting the LTE RACH. If the generated random number value is equal to or greater than the ac-Barring Factor, the timing specifying unit 144 conducts this processing repeatedly after waiting for the time period specified by the ac-Barring Time. The random number value generated by the timing specifying unit 144 is exemplified as “greater than 0 but less than 1” in the present embodiment.

The adjusting unit 150 is a processing unit for adjusting, on the basis of the 1×CSFallback flag information 125a, the ac-Barring Factor and the ac-Barring Time used by the timing specifying unit 144. The adjusting unit 150 adjusts the values of the ac-Barring Factor and the ac-Barring Time to advance the timing specified by the timing specifying unit 144 if the 1×CSFallback flag information 125a is “1”.

For example, the adjusting unit 150 sets the value of the ac-Barring Factor to “1.1” if the 1×CSFallback flag information 125a is “1”. By setting the ac-Barring Factor value to “1.1”, the value of the random number generated the first time will be smaller than the ac-Barring Factor since the value of the random number generated by the timing specifying unit 144 is “greater than 0 but less than 1” and thus the timing specified by the timing specifying unit 144 will be advanced.

Moreover, the adjusting unit 150 sets the value of the ac-Barring Time to a time period shorter than the time period set in the SIB information 125b if the 1×CSFallback flag information 125a is “1”. Due to the adjusting unit 150 adjusting the ac-Barring Time in this way, the frequency for generating random numbers increases, the probability that the random number value will be less than the ac-Barring Factor increases, and as a result the timing specified by the timing specifying unit 144 will be advanced.

In contrast, the adjusting unit 150 sets the values of the ac-Barring Factor and the ac-Barring Time registered in the SIB information 125b in the timing specifying unit 144 if the 1×CSFallback flag information 125a is “1”.

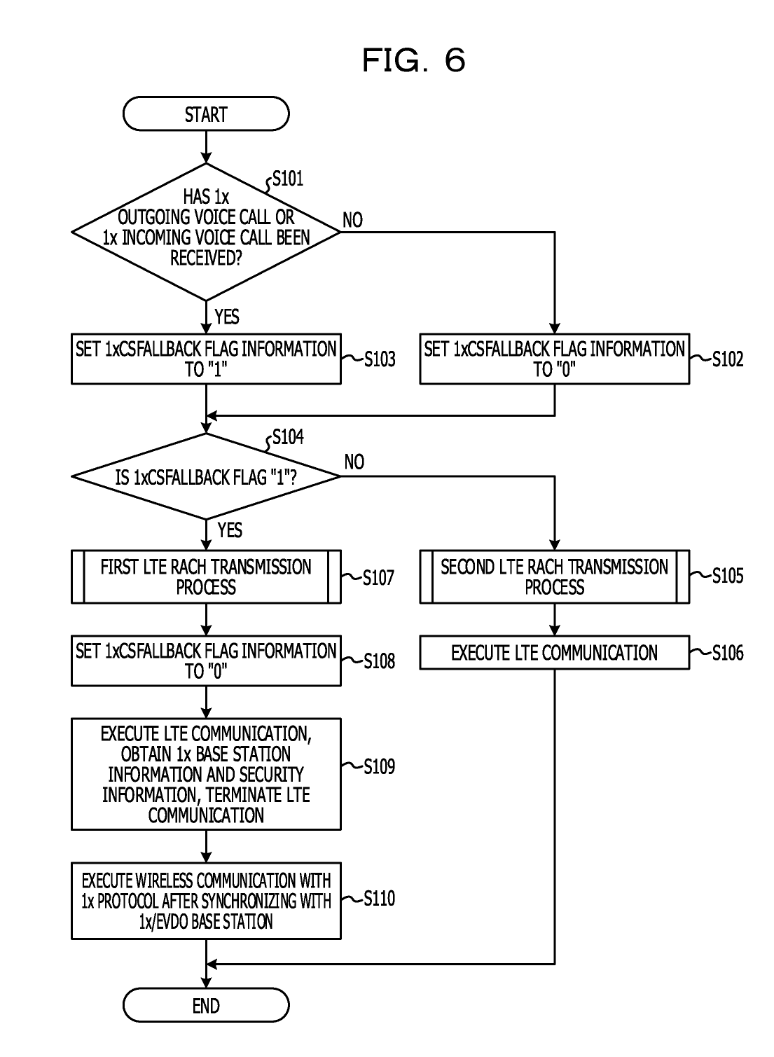

The following is an explanation of the operation of the multi-wireless terminal 100 according to the present embodiment. FIG. 6 is a flowchart of an example of operating procedures pertaining to a LTE RACH transmission by the multi-wireless terminal. The processing illustrated in FIG. 6 is, for example, executed upon the reception of a 1× incoming voice call or a 1× outgoing voice call. As illustrated in FIG. 6, the multi-wireless terminal 100 determines whether a 1× outgoing voice call or a 1× incoming voice call has been received (step S101).

If no 1× outgoing voice call or 1× incoming voice call has been received (step S101, No), the multi-wireless terminal 100 sets the 1×CSFallback flag information 125a to “0” (step S102) and then the process moves to step S104.

Conversely, if a 1× outgoing voice call or a 1× incoming voice call has been received (step S101, Yes), the multi-wireless terminal 100 sets the 1×CSFallback flag information 125a to “1” (step S103) and then the process moves to step S104.

The multi-wireless terminal 100 determines whether or not the 1×CSFallback flag information 125a is “1” (step S104). If the 1×CSFallback flag information 125a is “0” (step S104, No), the multi-wireless terminal 100 executes a second LTE RACH transmission process (step S105). The second LTE RACH transmission process indicated in step S105 is the same as the conventional LTE RACH transmission process and the operating procedures are the same as those illustrated in FIG. 10 for example. The multi-wireless terminal 100 executes LTE communication (step S106) and then ends the processing.

Conversely, if the 1×CSFallback flag information 125a is “1” (step S104, Yes), the multi-wireless terminal 100 executes a first LTE RACH transmission process (step S107). The first LTE RACH transmission process indicated in step S107 is a process for advancing the process to transmit the LTE RACH and then transmitting the LTE RACH.

The multi-wireless terminal 100 sets the 1×CSFallback flag information 125a to “0” (step S108), executes LTE communication, obtains the 1× base station information and the security information, and then terminates the LTE communication (step S109). The multi-wireless terminal 100 executes wireless communication with the 1× protocol after synchronizing with the 1×/EVDO base station 6A (step S110).

The following is a detailed explanation of the operating procedures for the first LTE RACH transmission process indicated in step S107. The operating procedures are divided as an example into operating procedures for adjusting the ac-Barring Time value and operating procedures for advancing the processing to transmit the LTE RACH when the ac-Barring Factor value is adjusted and the process to transmit the LTE RACH is advanced. Values based on the SIB information 125b are set for the ac-Barring Factor and the ac-Barring Time.

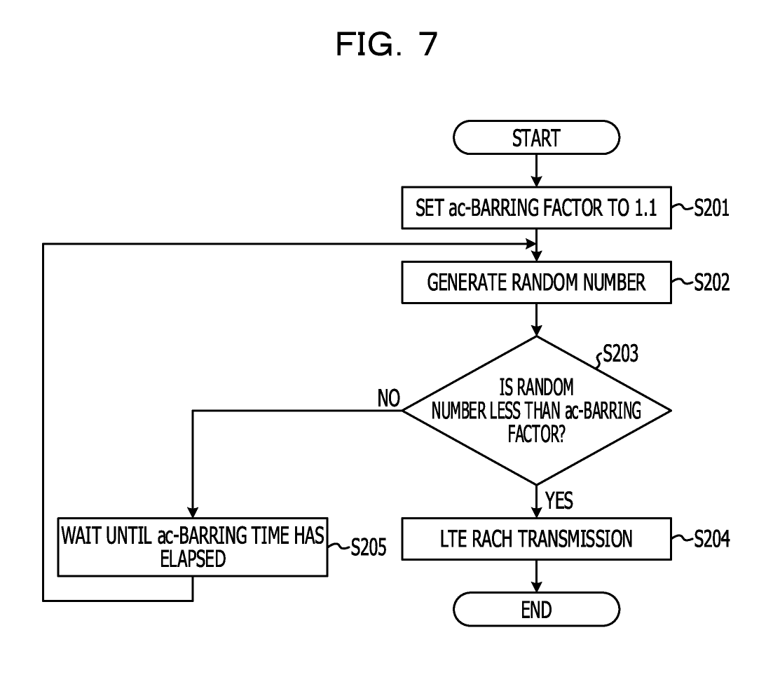

FIG. 7 is a first flowchart of operating procedures of a first LTE RACH transmission process. FIG. 7 illustrates operating procedures for adjusting the ac-Barring Factor and advancing the process to transmit the LTE RACH. As illustrated in FIG. 7, the multi-wireless terminal 100 sets the ac-Barring Factor to “1.1” (step S201) and generates a random number (step S202). The value of the random number generated by the multi-wireless terminal 100 is “greater than 0 but less than 1”.

The multi-wireless terminal 100 determines whether the random number is less than the ac-Barring Factor (step S203). If the random number is less than the ac-Barring Factor (step S203, Yes), the multi-wireless terminal 100 executes the LTE RACH transmission (step S204).

Conversely, if the random number is not less than the ac-Barring Factor (step S203, No), the multi-wireless terminal 100 waits until the ac-Barring Time has elapsed (step S205) and then the process returns to step S202. Since the random number is equal to or greater than the ac-Barring Factor in step S203, the processing in step S205 is not actually conducted.

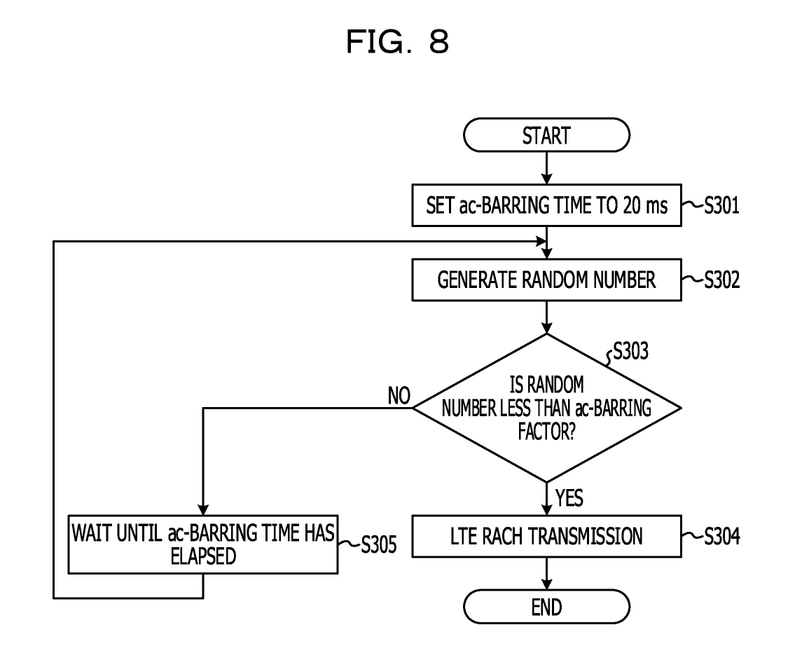

FIG. 8 is a second flowchart of operating procedures of the first LTE RACH transmission process. FIG. 8 illustrates operating procedures for adjusting the ac-Barring Time and advancing the process to transmit the LTE RACH. As illustrated in FIG. 8, the multi-wireless terminal 100 sets the ac-Barring Time to 20 ms (step S301) and generates a random number (step S302). The time period set for the ac-Barring Time in step S301 is a time period shorter than a time period based on the SIB information 125b.

The multi-wireless terminal 100 determines whether the random number is less than the ac-Barring Factor (step S303). If the random number is less than the ac-Barring Factor (step S303, Yes), the multi-wireless terminal 100 executes the LTE RACH transmission (step S304).

Conversely, if the random number is not less than the ac-Barring Factor (step S303, No), the multi-wireless terminal 100 waits until the ac-Barring Time has elapsed (step S305) and then the process returns to step S302.

The following is an explanation of the effects of the multi-wireless terminal 100 according to the present embodiment. When an outgoing or incoming voice call during LTE wireless connection is detected, the multi-wireless terminal 100 is able to reduce a delay of the outgoing or incoming voice call by advancing the LTE RACH transmission and reducing the time period until the wireless connection with the 1×/EVDO base station that is being used for the call is established. As a result, a 1×CSFallback terminal may be provided that is capable of carrying out a voice service without the user noticing any delay for outgoing or incoming voice calls.

The multi-wireless terminal 100 further generates random numbers in time intervals according to procedures determined by the LTE standard, and then specifies a timing in which the random number is less than a certain value determined by the LTE standard. When an incoming or outgoing voice call is detected during a LTE wireless connection, the multi-wireless terminal 100 is able to advance the LTE RACH transmission timing by following the procedures determined in the LTE standard by reducing the time interval or increasing the certain value in the processing for specifying the timing.

When a signal for notifying an incoming voice call or a request for an outgoing voice call is detected while communicating with the LTE protocol, the multi-wireless terminal 100 specifies a timing for transmitting a signal to request information about the 1× base station being used by the outgoing voice call or the incoming voice call data communication. As a result, switching to wireless communication using the 1× protocol may be carried out smoothly even if the wireless connection is disconnected due to the 1× protocol.

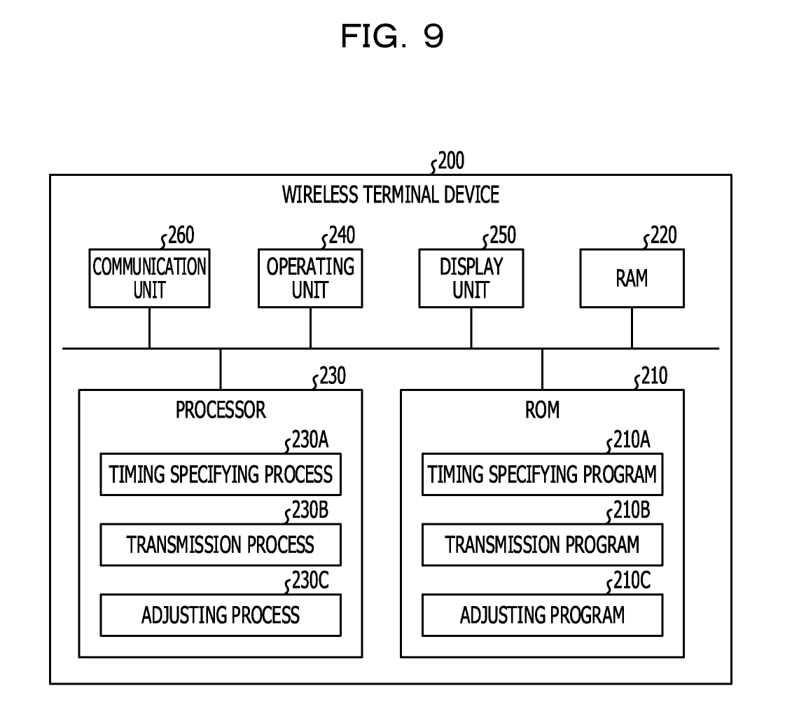

The various procedures described in the present embodiment may be performed by executing previously prepared programs on a wireless terminal device. In the following description, an example of a wireless terminal device executing a program that has functions similar to the above embodiment will be described. FIG. 9 describes a wireless terminal device for executing a control program.

A wireless terminal device 200 for executing a control program in FIG. 9 has a ROM 210, a RAM 220, a processor 230, an operating unit 240, a display unit 250, and a communication unit 260. Control programs for demonstrating functions similar to the above embodiment are pre-stored in the ROM 210. Instead of the ROM 210, the control programs may also be recorded on a recording medium that is capable of being read by a drive not illustrated in FIG. 9. A portable recording medium such as a CD-ROM, a DVD disc, a USB memory device or a SD card, or a semiconductor memory such as a flash memory device may be used as the recording medium. As illustrated in FIG. 9, the control programs include a timing specifying program 210A, a transmission program 210B, and an adjusting program 210C. The programs 210A to 210C may be integrated or distributed as appropriate.

The processor 230 reads the programs 210A to 210C from the ROM 210 and executes the read programs. The processor 230 then causes the programs 210A to 210C to function respectively as a timing specifying process 230A, a transmission process 230B, and an adjusting process 230C. For example, the timing specifying process 230A corresponds to the timing specifying unit 144 illustrated in FIG. 4. The transmission process 230B corresponds to the LTE RACH transmission unit 143. The adjusting process 230C corresponds to the adjusting unit 150. The communication unit 260 has a multiple wireless communication function with a plurality of communication protocols that includes the LTE protocol.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A wireless communication device comprising:
a memory; and
a processor coupled to the memory and configured to:
specify a timing for transmitting a signal for requesting information about a second base station that is used for voice data communication when conducting outgoing or incoming voice communication while conducting communication through a first base station that is used for data communication other than voice communication;
transmit, in accordance with the specified timing, the signal for requesting the information about the second base station; and
adjust by advancing the specified timing when a request for conducting incoming or outgoing voice communication is received.

2. The wireless communication device according to claim 1, wherein the processor:
generates a random number at a certain time period interval in accordance with a procedure determined in the Long Term Evolution (LTE) standard, and specifies a timing in which the random number is smaller than a certain value; and
shortens the time period interval or decreases the certain value.

3. The wireless communication device according to claim 1, wherein the processor:
specifies a timing for transmitting a signal to request information about a 1× base station being used for outgoing voice call or the incoming voice call data communication when a signal for notifying an incoming voice call or a request for an outgoing voice call is detected while conducting communication with the LTE protocol.

4. A machine readable medium storing a program that, when executed by a processor, causes the processor to perform operations comprising:
specifying a timing for transmitting a signal for requesting information about a second base station that is used for voice data communication when conducting outgoing or incoming voice communication while conducting communication through a first base station that is used for data communication other than voice communication;
conducting a process to transmit, in accordance with the specified timing, the signal for requesting the information about the second base station; and
conducting a process to advance the timing for transmitting the signal for requesting information about the second base station that is used for voice data communication when a request for conducting incoming or outgoing voice communication is received.

5. The machine readable medium storing a program according to claim 4, wherein
the process for specifying the timing includes generating a random number at a certain time period interval in accordance with a procedure determined in the Long Term Evolution (LTE) standard, and a process for advancing the timing by shortening the time period interval or decreasing the certain value.

6. The machine readable medium storing a program according to claim 4, wherein
the process for specifying the timing includes specifying a timing for transmitting a signal to request information about the second base station that is used for voice data communication when conducting outgoing or incoming voice communication while conducting communication through a first base station that is used for data communication other than voice communication.

7. A control method comprising:
specifying a timing for transmitting a signal for requesting information about a second base station that is used for voice data communication when conducting outgoing or incoming voice communication while conducting communication through a first base station that is used for data communication other than voice communication;
conducting a process to transmit, in accordance with the specified timing, the signal for requesting the information about the second base station; and
conducting, by a processor, a process to advance the timing for transmitting the signal for requesting information about the second base station that is used for voice data communication when a request for conducting incoming or outgoing voice communication is received.

8. The control method according to claim 7, wherein the process for specifying the timing includes:
generating a random number at a certain time period interval in accordance with a procedure determined in the Long Term Evolution (LTE) standard, and specifying a timing in which the random number is smaller than a certain value; and
the process for advancing the timing involves shortening the time period interval or decreasing the certain value.

9. The control method according to claim 7, wherein the process for specifying the timing includes:
specifying a timing for transmitting a signal for requesting information about the second base station that is used for voice data communication when conducting outgoing or incoming voice communication while conducting communication through a first base station that is used for data communication other than voice communication.
